(19) United States
(12) Patent Application Publication
(10) Pub. No.: US 2020/0171943 A1
(43) Pub. Date: Jun. 4, 2020

(54) REACTION FORCE CONTROL SYSTEM FOR ACCELERATOR PEDAL

(71) Applicant: TOYOTA JIDOSHA KABUSHIKI KAISHA, Toyota-shi (JP)

(72) Inventor: Hideaki OTSUBO, Aichi-gun (JP)

(73) Assignee: TOYOTA JIDOSHA KABUSHIKI KAISHA, Toyota-shi (JP)

(21) Appl. No.: 16/677,894

(22) Filed: Nov. 8, 2019

(30) Foreign Application Priority Data
Dec. 4, 2018 (JP) 2018-227317

(51) Int. Cl. B60K 26/02; G08G 1/133; G08G 1/01; B60W 40/04

(52) U.S. Cl. CPC B60K 26/021; G08G 1/133; B60W 2540/10; B60W 40/04; B60K 2026/023; G08G 1/01

(57) ABSTRACT

A reaction force control system configured to alleviate traffic congestion without providing discomfort to a driver. The reaction force control system comprises a reaction force generating mechanism generating a reaction force against a pedal force, and a controller that controls the reaction force generating mechanism. The controller is configured to: obtain a current reaction force and calculate a target reaction force when the vehicle travels within a speed management zone; reduce the reaction force when the current reaction force is greater than the target reaction force; and increase the reaction force when the current reaction force is less than the target reaction force.

### CROSS REFERENCE TO RELATED APPLICATIONS

The present disclosure claims the benefit of Japanese Patent Application No. 2018-227317 filed on Dec. 4, 2018 with the Japanese Patent Office, the disclosure of which are incorporated herein by reference in its entirety.

### BACKGROUND

### Field of the Disclosure

Embodiments of the present application relate to the art of a control system for controlling a reaction force against a pedal force applied to an accelerator pedal.

### Discussion of the Related Art

In recent years, various kinds of control systems for alleviating traffic congestion have been developed. For example, in order to alleviate road congestion by controlling the vehicle to follow a preceding vehicle while keeping a distance from a preceding vehicle, an autonomous operation system and a cruise control system are available in the conventional art. However, number of the autonomous vehicle and vehicles having the cruise control system is still small. In addition, even if a vehicle is provided with the cruise control system, the vehicle may not always be controlled by the cruise control system. That is, most of the vehicles are still operated manually, and hence it is necessary to propose a solution to alleviate traffic congestion in circumstances where most of the vehicles are still operated manually.

JP-A-2018-010552 describes a device and a method for assisting a vehicle to moderate road congestion by controlling a vehicle speed. According to the teachings of JP-A-2018-010552, an appropriate vehicle speed to alleviate traffic congestion is calculated based on detected traffic information and situations of other vehicles. The calculated appropriate vehicle speed is reported to the driver visually or aurally so that the driver is allowed to operate an accelerator pedal and a brake pedal in such a manner as to achieve the appropriate vehicle speed.

JP-A-2013-136381 describes a control system for a vehicle having a cruise control system configured to alleviate traffic congestion by controlling a distance from a preceding vehicle, in a situation where vehicles in which the cruise control is available and vehicles in which the cruise control is not available exist in the traffic.

However, even if the driver is notified of the appropriate speed to alleviate traffic congestion as taught by JP-A-2018-010552, the driver may not always operate the accelerator pedal and the brake pedal to adjust the vehicle speed to the appropriate speed. In addition, the driver may also be notified of road information by an external media such as a road sign. For example, a road sign notifying the driver to maintain a speed of the vehicle is set at a place where congestion is expected to be caused such as a sagging section. However, such road sign may also not be effective enough to alleviate traffic congestion. That is, a slight change in the vehicle speed is an important factor to cause traffic congestion, but it is difficult for the driver to sense such slight change in the vehicle speed and adjust the vehicle speed to the appropriate speed to alleviate the congestion.

In addition, if the vehicle speed is changed compulsory to the speed appropriate to solve the congestion by changing a driving force despite the intension of the driver irrespective of an operation of the accelerator pedal, the driver may feel uncomfortable feeling. Even if the vehicle is provided with the cruise control system as taught by JP-A-2013-136381, it is insufficient to alleviate the congestion in the traffic in which most of the vehicles are not provided with the cruise control system. Therefore, a manually operated vehicle has to be improved to alleviate traffic congestion.

### SUMMARY

Aspects of the present disclosure have been conceived noting the foregoing technical problems, and it is therefore an object of the present disclosure to provide a reaction force control system configured to alleviate traffic congestion without providing uncomfortable feeling to a driver.

Embodiment of the present disclosure relates to a reaction force control system for an accelerator pedal, comprising: a reaction force generating mechanism that generates a reaction force against a pedal force applied to the accelerator pedal from a driver; and a controller that controls the reaction force generating mechanism. In order to achieve the above-explained objective, according to the embodiment of the present disclosure, the controller is configured to: determine whether the vehicle currently travels within a speed management zone; obtain a current reaction force generated by the reaction force generating mechanism and calculate a target reaction force against the pedal force applied to the accelerator pedal from the driver, when the vehicle travels within the speed management zone; reduce the reaction force when the current reaction force is greater than the target reaction force; and increase the reaction force when the current reaction force is less than the target reaction force.

In a non-limiting embodiment, the controller may be further configured to: reduce the reaction force at a predetermined change rate possible to reduce uncomfortable feeling of the driver; and increase the reaction force at the predetermined change rate possible to reduce uncomfortable feeling of the driver.

In a non-limiting embodiment, the controller may be further configured to: obtain the current reaction force based on an operating amount of the accelerator pedal; calculate the target reaction force based on the current reaction force and a correction amount of the reaction force; calculate the correction amount based on a difference between a current speed of the vehicle and a target speed of the vehicle; increase the reaction force by the correction amount when the current speed of the vehicle is higher than the target speed; and reduce the reaction force by the correction amount when the current speed of the vehicle is lower than the target speed.

In a non-limiting embodiment, the controller may be further configured to: obtain the current reaction force based on an operating amount of the accelerator pedal; calculate the target reaction force based on the current reaction force and a correction amount of the reaction force; calculate the correction amount based on a difference between a current distance from a preceding vehicle and a target distance from the preceding vehicle; increase the reaction force by the correction amount when the current distance from the preceding vehicle is shorter than the target distance from the preceding vehicle; and reduce the reaction force by the correction amount when the current distance from the preceding vehicle is longer than the target distance from the preceding vehicle.

In a non-limiting embodiment, the controller may be further configured to: obtain the current reaction force based on an operating amount of the accelerator pedal; calculate the target reaction force based on the current reaction force and a correction amount of the reaction force; calculate the correction amount based on a difference between a current acceleration of the vehicle and a target acceleration of the vehicle; increase the reaction force by the correction amount when the current acceleration of the vehicle is greater than the target acceleration; and reduce the reaction force by the correction amount when the current acceleration of the vehicle is less than the target acceleration.

In a non-limiting embodiment, the controller may be further configured to obtain the current reaction force based on an operating amount of the accelerator pedal; calculate the target reaction force based on the current reaction force and a correction amount of the reaction force; calculate the correction amount based on a difference between a current drive force and a target drive force; increase the reaction force by the correction amount when the current drive force is greater than the target drive force; and reduce the reaction force by the correction amount when the current drive force of the vehicle is less than the target drive force.

In a non-limiting embodiment, speed management zone may include a zone where traffic congestion is expected to be caused, and the controller may be further configured to determine whether traffic congestion is expected to be caused based on a road gradient or a travelling route.

Thus, according to the embodiment of the present disclosure, the reaction force against the pedal force applied to the accelerator pedal from the driver is corrected to achieve the target reaction force in the speed management zone where traffic congestion is expected to be caused. For example, if the current reaction force is greater than the target reaction force, the reaction force is reduced. Consequently, the accelerator pedal is further depressed by a current pedal force to increase the drive force to propel the vehicle. By contrast, if the current reaction force is smaller than the target reaction force, the reaction force is increased. Consequently, the accelerator pedal is returned to a certain extent unless the pedal force is changed by the driver. According to the embodiment of the present disclosure, therefore, the speed of the vehicle can be adjusted to the target speed possible to alleviate traffic congestion within the speed management zone.

In addition, according to the embodiment of the present disclosure, the reaction force against the pedal force applied to the accelerator pedal is adjusted gradually at the rate possible to reduce uncomfortable feeling of the driver. According to the embodiment of the present disclosure, therefore, the speed of the vehicle can be adjusted to the speed possible to alleviate traffic congestion without providing discomfort to the driver.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing one example of a structure of a vehicle to which the reaction force control system according to the embodiment of the present disclosure is applied;

FIG. 2 is a schematic illustration showing one example of a structure of an accelerator pedal to which the reaction force control system according to the embodiment of the present disclosure is applied;

FIG. 3 is a flowchart showing an example of a routine executed by the reaction force control system according to the embodiment of the present disclosure;

FIG. 4 is a map determining a correction amount of reaction force used to prevent a reduction in a speed of the vehicle;

FIG. 5 is a map determining a correction amount of reaction force used to prevent an increase in a speed of the vehicle;

FIG. 6 is a graph indicating a position of the accelerator pedal changed by reducing the reaction force;

FIG. 7 is a graph indicating a drive force changed by reducing the reaction force;

FIG. 8 is a graph indicating a position of the accelerator pedal changed by increasing the reaction force; and

FIG. 9 is a flowchart showing another example of a routine executed by the reaction force control system according to the embodiment of the present disclosure.

### DETAILED DESCRIPTION OF THE PREFERRED EMBODIMENT(S)

Embodiments of the present invention will now be explained with reference to the accompanying drawings. Note that the embodiments shown below are merely examples of the present disclosure, and do not limit a scope of the present disclosure.

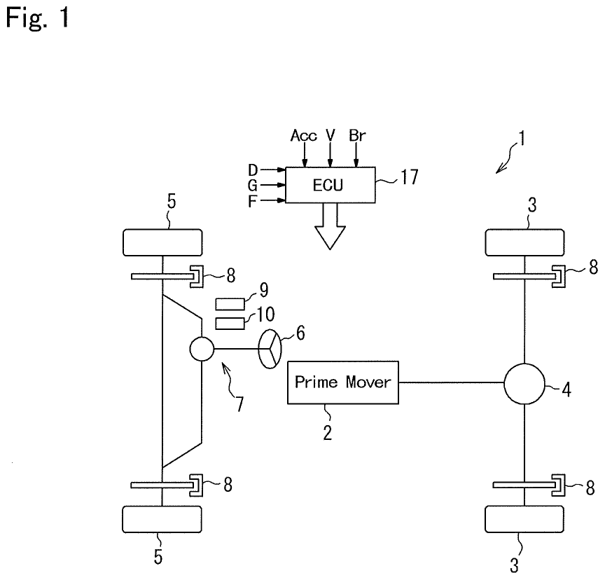

Referring now to FIG. 1, there is schematically shown a structure of a vehicle 1 to which the reaction force control system according to the embodiment of the present disclosure is applied. The vehicle 1 is a rear-drive layout vehicle operated manually by a driver in which a pair of rear wheels 3 is driven by an output torque of a prime mover 2 to propel the vehicle 1. The prime mover 2 may include an internal combustion engine, a motor, and both of the engine and the motor. A differential gear unit 4 is connected to the prime mover 2 so that a drive force generated by the prime mover 2 is distributed to the right rear wheel 3 and the left rear wheel 3. A pair of front wheels 5 is turned by rotating a steering wheel 6 of a steering mechanism 7. Each of the front wheels 5 and the rear wheels 3 is individually provided with a brake device 8. Not only an electric brake device but also a hydraulic brake device may be adopted as each of the brake devices 8, and each of the brake devices 8 is activated upon reception of a braking command signal transmitted in response to a braking operation.

The vehicle 1 is provided with an accelerator pedal 9 for accelerating and decelerating the vehicle 1, and a brake pedal 10 for applying a brake force to the vehicle 1.

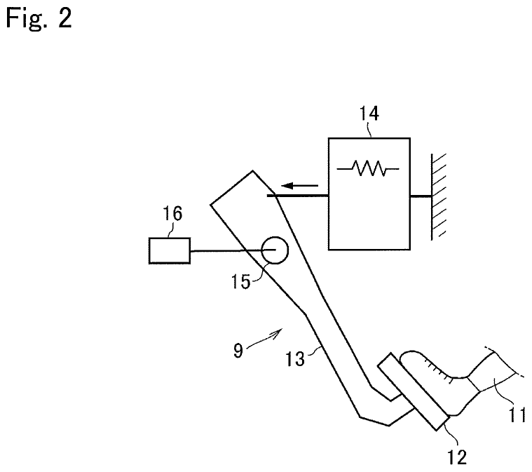

A structure of the accelerator pedal 9 is shown in FIG. 2 in more detail. The accelerator pedal 9 includes a pedal arm 13 suspended from a vehicle body toward a floor (neither of which are shown) in such a manner as to pivot about a fulcrum (or shaft) 15, and a pedal pad 12 attached to a leading end of the pedal arm 13 to receive a pedal force applied from the driver 11. The accelerator pedal 9 is returned to an idle position by a pushing force generated by a reaction force generating mechanism 14, and the pushing force of the reaction force generating mechanism 14 acts as a reaction force against the pedal force applied from the driver 11.

A drive force generated by the prime mover to propel the vehicle 1, that is, an engine torque or a motor torque is changed in accordance with a depression (or stroke) of the accelerator pedal 9.

An operating amount (or a position) and an operating speed of the accelerator pedal 9 is detected by an accelerator sensor 16. For example, an angle sensor for detecting an angle of the pedal arm 13 from the idle position when the pedal force is applied to or reduced from the pedal pad 12 by the driver 11 may be adopted as the accelerator sensor 15. A detection value of the accelerator sensor 15 is transmitted to an after-mentioned electronic control unit (to be abbreviated as the “ECU” hereinafter) 17 in the form of electric signal.

In order to adjust the reaction force against the pedal force applied to the pedal pad 12, the reaction force generating mechanism 14 is provided with an actuator. For example, a motor may be adopted as the actuator of the reaction force generating mechanism 14, and the reaction force against the pedal force applied to the pedal pad 12 is adjusted in accordance with a position of the accelerator pedal 9 by controlling the motor. In order to return the accelerator pedal 9 to the idle position, the reaction force generating mechanism 14 is further provided with a return spring.

Although not especially shown, the brake pedal 10 also includes a lever and a pedal pad attached to a leading end of the lever. That is, the brake pedal 10 is also pivoted about a predetermined fulcrum to be depressed by applying a pedal force to the pedal pad. When the brake pedal 10 is depressed, the brake pedal 10 transmits an electric or hydraulic brake signal to actuate the brake devices 8.

Turning back to FIG. 1, in order to control the prime mover 2, the reaction force generating mechanism 14 and so on, the vehicle 1 is provided with the ECU 17 as a controller. The ECU 17 comprises a microcomputer configured to execute a calculation based on incident signals and data installed in advance, and to transmit a calculation result in the form of command signal. To this end, for example, the ECU 17 receives data about a vehicle speed V detected by a vehicle speed sensor, a position ACC of the accelerator pedal 9 detected by the accelerator sensor 16, an activation signal Br transmitted from the brake device 8 when the brake pedal 10 is depressed, a distance D from other vehicle detected by an inter-vehicle communication system, an acceleration (o deceleration) G detected by an acceleration sensor, a drive force F and so on. The data installed in the ECU 17 includes a map determining a characteristic of a reaction force against a pedal force applied to the accelerator pedal 9, a map determining a correction amount of the reaction force against the pedal force based on a difference between an actual value and a target value of e.g., a vehicle speed and so on. For example, the ECU 17 transmits command signals for controlling an output torque of the prime mover 2, a reaction force of the reaction force generating mechanism 14 and so on.

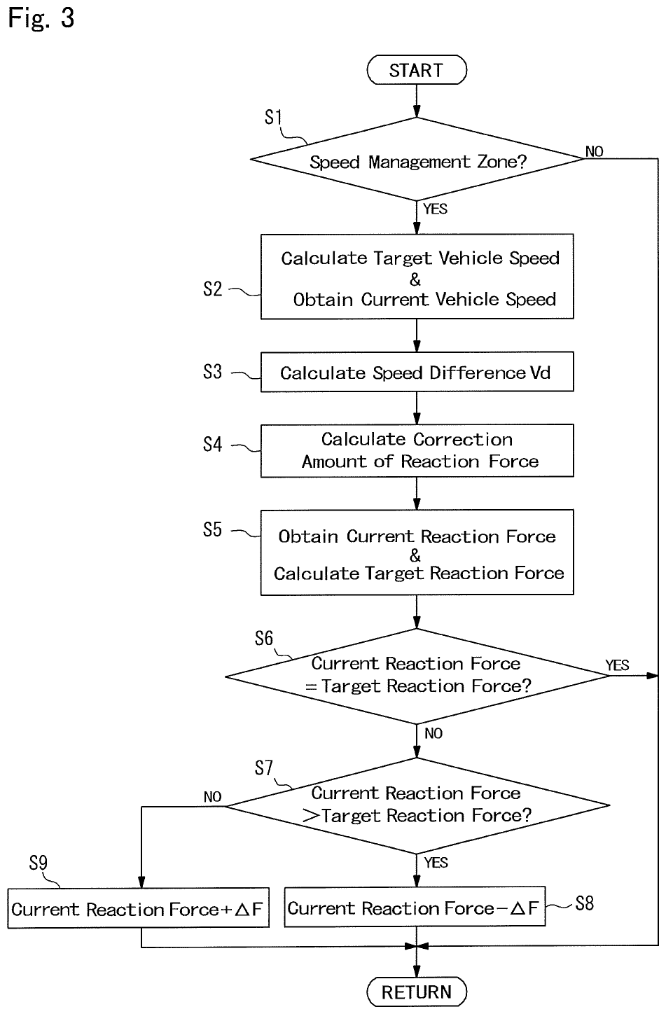

Thus, the vehicle 1 is accelerated and decelerated by manipulating the accelerator pedal 9 and the brake pedal 10. However, if a road gradient slightly varies e.g., in a sagging section of the road but the driver 11 does not notice such change in the road gradient, the driver 11 may not especially operate the accelerator pedal 9 or the brake pedal 10 to maintain a vehicle speed and the vehicle speed will be changed unintentionally. Such unintentional change in the vehicle speed may be a cause of traffic congestion. If the vehicle speed is controlled compulsory irrespective of an operation (or intension) of the driver 11 for the purpose of avoiding traffic congestion, the driver 11 may feel uncomfortable feeling. In order to control a speed of the vehicle 1 in such a manner as to avoid causing traffic congestion without providing discomfort to the driver, the ECU 17 executes the routine shown in FIG. 3 repeatedly at predetermined time interval.

Specifically, the ECU 17 is configured to execute the routine shown in FIG. 3 so as to control a reaction force generated by the reaction force generating mechanism 14 against a pedal force applied to the accelerator pedal 9 from the driver 11 (as will be simply called the “reaction force” hereinafter) in accordance with a speed of the vehicle 1. At step S1, it is determined whether the vehicle 1 currently travels within a speed management zone where a speed of the vehicle 1 may be changed slightly and hence traffic congestion is expected to be caused. For example, the speed management zone includes a slight upward slope, a sagging site, an entrance of a tunnel etc. of a highway or expressway at which traffic congestion is expected to be caused by a slight change in a speed of each vehicle travelling therethrough. Instead, such determination at step S1 may also be made before entering into the speed management zone to determine whether the vehicle 1 will enter into the speed management zone. For example, such determination at step S1 may be made based on information received from an external traffic control system, or a planned travelling route set by a navigation system. If the vehicle 1 currently does not travels within the speed management zone or will not enter into the speed management zone so that the answer of step S1 is NO, the routine returns without executing any specific control.

By contrast, if the vehicle 1 travels within the speed management zone or the vehicle 1 is expected to enter into the speed management zone so that the answer of step S1 is YES, the routine progresses to step S2 to calculate a target speed of the vehicle 1 which can avoid causing traffic congestion, and to obtain a current speed of the vehicle 1. For example, the target speed of the vehicle 1 may be calculated based on the information received from the external traffic control system or obtained by the navigation system. Instead, the target speed of the vehicle 1 may also be calculated based on a distance from a preceding vehicle calculated based on information obtained through the inter-vehicle communication. On the other hand, the current speed of the vehicle 1 may be detected by the vehicle speed sensor. Then, at step S3, a speed difference Vd between the target vehicle speed and the current vehicle speed obtained at step S2 is calculated.

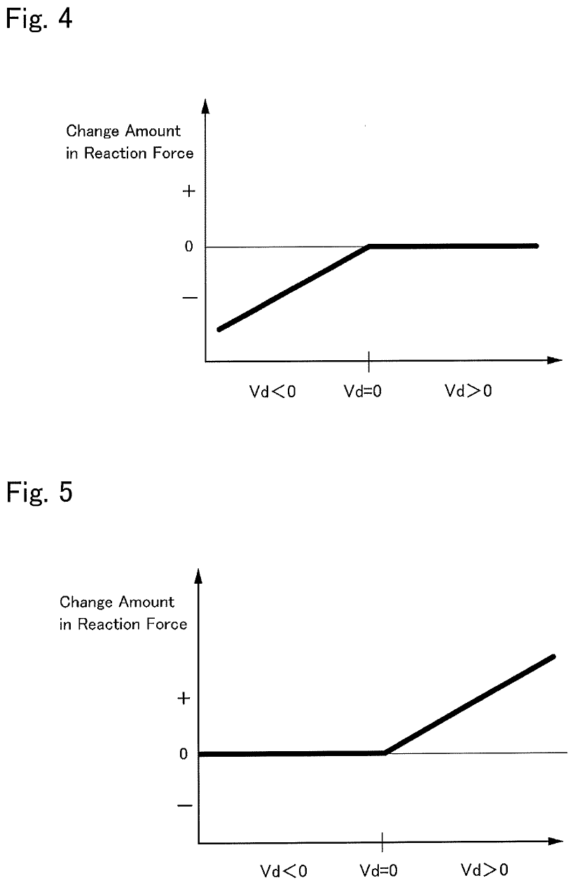

Then, at step S4, a correction amount of the reaction force against the pedal force applied to the pedal pad 12 from the driver (i.e., an amount of change in the reaction force) is calculated based on the speed difference Vd calculated at step S3 with reference to maps shown in FIGS. 4 and 5. Specifically, FIG. 4 shows a map used when the vehicle 1 travels on a slight upslope to prevent an unintentional reduction in the speed of the vehicle 1. As can be seen from FIG. 4, if the speed difference Vd is negative, that is, if the current speed of the vehicle 1 is lower than the target speed, the reaction force is reduced. On the other hand, FIG. 5 shows a map used when the vehicle 1 travels on a slight downslope to prevent an unintentional increase in the speed of the vehicle 1. As can be seen from FIG. 5, if the speed difference Vd is positive, that is, if the current speed of the vehicle 1 is higher than the target speed, the reaction force is increased. As described, the map shown in FIG. 4 is used to prevent an unintentional reduction in the speed of the vehicle 1. Therefore, if the speed difference Vd is greater than zero, the amount of change in the reaction force is zero, that is, the reaction force will not be corrected. Likewise, the map shown in FIG. 5 is used to prevent an unintentional increase in the speed of the vehicle 1. Therefore, if the speed difference Vd is less than zero, the amount of change in the reaction force is zero, that is, the reaction force will not be corrected. Here, the maps shown in FIGS. 4 and 5 may be integrated.

Then, at step S5, a current reaction force generated by the reaction force generating mechanism 14 is obtained, and a target reaction force to adjust the current speed of the vehicle 1 to the target speed is calculated. Specifically, the target reaction force is calculated by adding the correction amount of the reaction force calculated with reference to FIG. 4 or 5 to the current reaction force. Instead, the target reaction force may also be calculated based only on the target speed of the vehicle 1. Optionally, the target reaction force may also be calculated taking account of a road gradient or a running resistance within the speed management zone. On the other hand, the current reaction force may be obtained based on the current speed of the vehicle 1, or a stroke (or an operating amount) of the accelerator pedal 9. Thereafter, at step S6, it is determined whether the current reaction force is equal to the target reaction force, or whether the current reaction force falls within a target range of the reaction force determined taking account of a predetermined error.

If the current reaction force is equal to the target reaction force so that the answer of step S6 is YES, the ECU 17 determines that it is possible to avoid causing traffic congestion. In this case, therefore, the routine returns.

By contrast, if the current reaction force is not equal to the target reaction force so that the answer of step S6 is YES, the routine progresses to step S7 to determine whether the current reaction force is greater than the target reaction force. If the current reaction force is greater than the target reaction force so that the answer of step S7 is YES, the routine progresses to step S8 to reduce the current reaction force to the target reaction force. At step S8, specifically, the reaction force is decremented by a predetermined change amount ΔF to the target reaction force. In this case, since the speed of the vehicle 1 is unintentionally reduced lower than the target speed, traffic congestion is expected to be caused due to such reduction in the speed of the vehicle 1. At step S8, therefore, the reaction force is reduced at a predetermined change rate determined by the map shown in FIG. 4. In this situation, if the reaction force is reduced abruptly to the target reaction force, a stroke of the accelerator pedal 9, a drive force, a vehicle speed etc. will be changed abruptly and hence the driver 11 may feel uncomfortable feeling. Therefore, the change rate of the reaction force is set in such a manner as to reduce the reaction force gradually so as to reduce uncomfortable feeling.

By contrast, if the current reaction force is less than the target reaction force so that the answer of step S7 is NO, the routine progresses to step S9 to increase the current reaction force to the target reaction force. At step S9, specifically, the reaction force is incremented by the change amount ΔF to the target reaction force. In this case, since the speed of the vehicle 1 is unintentionally increased higher than the target speed, traffic congestion is also expected to be caused due to such increase in the speed of the vehicle 1. At step S9, therefore, the reaction force is increased at a predetermined change rate determined by the map shown in FIG. 5. In this situation, if the reaction force is increased abruptly to the target reaction force, a stroke of the accelerator pedal 9, a drive force, a vehicle speed etc. will also be changed abruptly and hence the driver 11 may feel uncomfortable feeling. Therefore, the change rate of the reaction force is also set in such a manner as to increase the reaction force gradually.

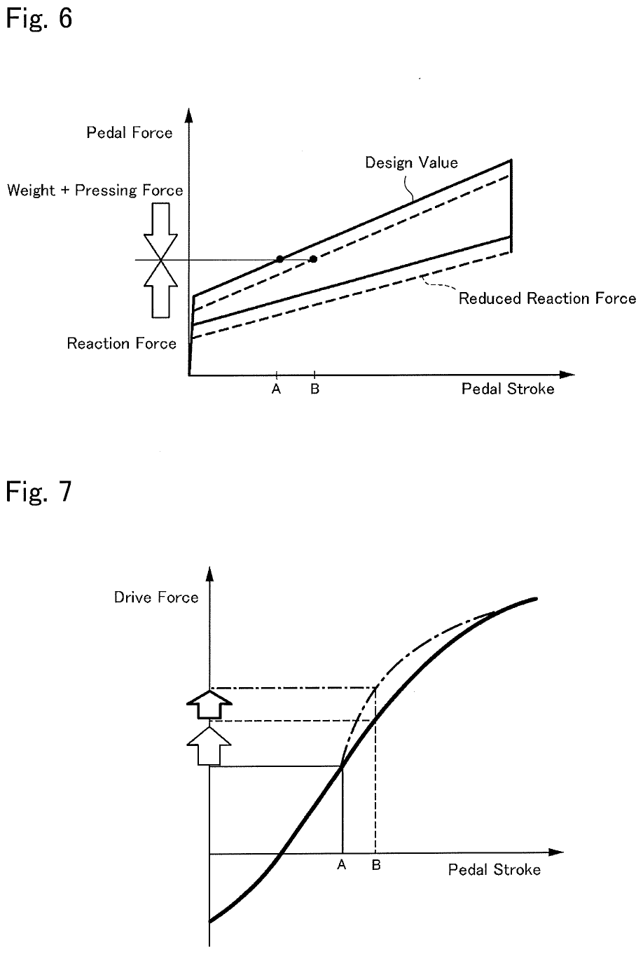

Thus, when the vehicle 1 travels within the speed management zone or the vehicle 1 is expected to enter into the speed management zone, the reaction force against the pedal force applied to the accelerator pedal 9 is corrected by the correction amount which can adjust the vehicle speed to the speed possible to avoid causing traffic congestion. For example, in the case that the current reaction force is greater than the target reaction force, the reaction force is reduced to the target reaction force at the predetermined change rate (or by a predetermined change amount). In this case, specifically, the reaction force is reduced as indicated in FIG. 6. In FIG. 6, the solid line represents a design value of the reaction force, and the dashed line represents the reaction force reduced at step S8. The design value of the reaction force is set based on a result of experimentation or simulation carried out on the precondition that the vehicle is operated by a driver having a standard body shape. In the case that the vehicle 1 does not travel within the speed management zone and a predetermined pedal force governed by a weight of a foot of the driver and a pressing force applied from the driver is applied to the accelerator pedal 9, the accelerator pedal 9 is depressed to a position A. By contrast, in the case that the reaction force is reduced at step S8 and the same pedal force is applied to the accelerator pedal 9, the accelerator pedal 9 is further depressed to a position B. Optionally, an amount of decrease in the reaction force may be slightly increased taking account of a hysteresis.

As a result of thus reducing the reaction force, as shown in FIG. 7, the drive force to propel the vehicle 1 is increased. In FIG. 7, the vertical axis represents the drive force, the horizontal axis represents the position of the accelerator pedal, the solid curve represents the drive force generated when the design value of the reaction force is applied to the accelerator pedal 9, and the dashed curve represents the drive force generated when the reaction force is reduced. As can be seen from FIG. 7, in the case that the vehicle 1 does not travel within the speed management zone and the accelerator pedal 9 is depressed to the position A by the predetermined pedal force, the drive force to propel the vehicle 1 is relatively small as indicated by the solid curve. By contrast, in the case that the reaction force is reduced at step S8 and the same pedal force is applied to the accelerator pedal 9, the accelerator pedal 9 is further depressed to a position B so that the drive force to propel the vehicle 1 is increased as indicated by the dashed curve.

By thus increasing the drive force to propel the vehicle 1, a speed of the vehicle 1 is increased toward the target speed. As a result, traffic congestion within the speed management zone is alleviated.

That is, by thus changing the position of the accelerator pedal 9, the speed of the vehicle 1 can be increased to the target speed promptly to prevent an unintentional reduction in the speed of the vehicle 1. For this reason, it is possible to alleviate traffic congestion within the speed management zone.

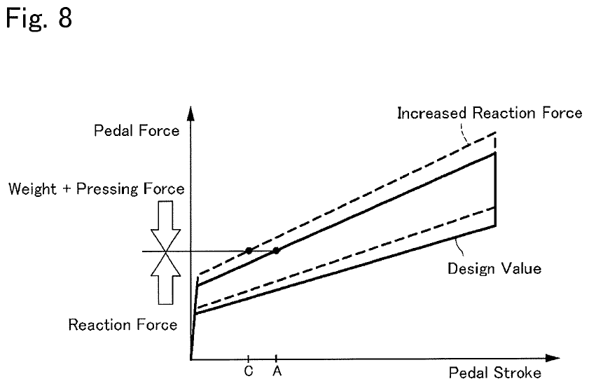

By contrast, in the case that the current reaction force is smaller than the target reaction force, the reaction force is increased to the target reaction force as indicated in FIG. 8. In FIG. 8, the solid line also represents the design value of the reaction force, and the dashed line represents the reaction force increased at step S9. As the example shown in FIGS. 6 and 7, in the case that the vehicle 1 does not travel within the speed management zone and the predetermined pedal force is applied to the accelerator pedal 9, the accelerator pedal 9 is depressed to the position A. By contrast, in the case that the reaction force is increased at step S9 and the same pedal force is applied to the accelerator pedal 9, the accelerator pedal 9 is returned to a position C so that the drive force to propel the vehicle 1 is reduced. As a result, a speed of the vehicle 1 is reduced toward the target speed. For this reason, an occurrence of traffic congestion due to unintentional increase in the speed of the vehicle 1 within the speed management zone can be prevented.

Thus, in the speed management zone, the speed of the vehicle 1 is adjusted to the target speed possible to alleviate traffic congestion by adjusting the reaction force against the pedal force applied to the accelerator pedal 9. In addition, the reaction force is changed gradually to the target reaction force so that the drive force to propel the vehicle 1 will not be changed abruptly. For this reason, the speed of the vehicle 1 can be adjusted to the target speed without providing discomfort to the driver. In other words, the reaction force is changed gradually to adjust the speed of the vehicle 1 without being noticed by the driver. Since the position of the accelerator pedal is thus adjusted to propel the vehicle 1 at the target speed possible to alleviate traffic congestion, uncomfortable feeling of the driver can be reduced compared to a case of changing the drive force compulsory to alleviate traffic congestion.

The reaction force control system according to the embodiment of the present disclosure may also be applied to an autonomous vehicle and a vehicle having a cruise control system. Optionally, in order to enhance a control accuracy, the reaction force may also be controlled in such a manner as to adjust that the speed of the vehicle 1 to a lower limit speed or an upper limit speed.

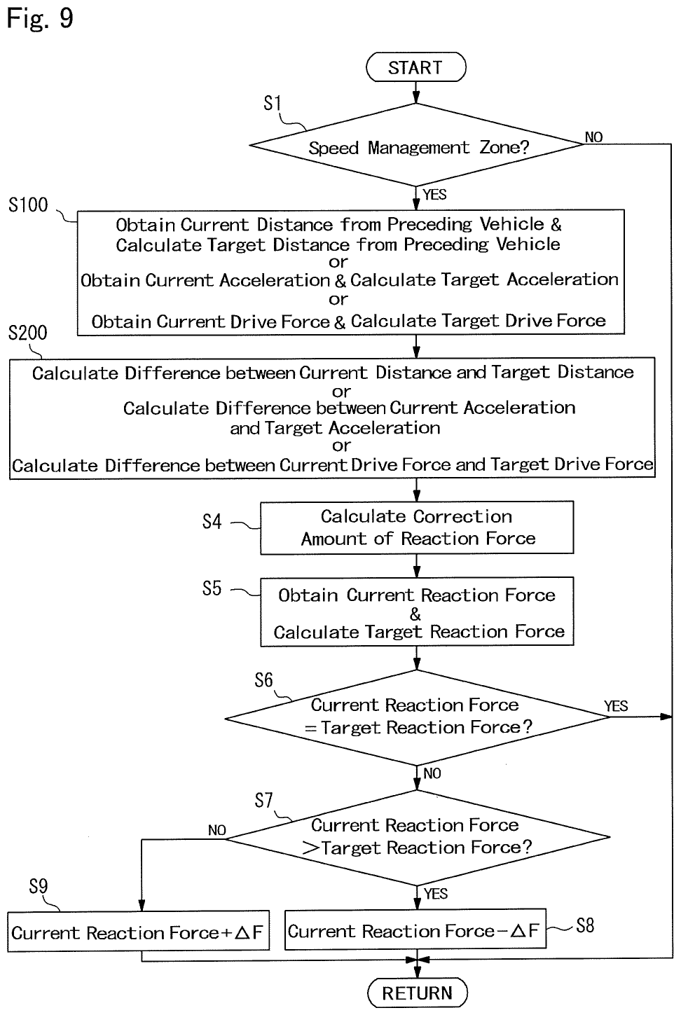

Although the above exemplary embodiments of the present disclosure have been described, it will be understood by those skilled in the art that the present disclosure should not be limited to the described exemplary embodiments, and various changes and modifications can be made within the scope of the present disclosure. For example, the correction amount of the reaction force against the pedal force applied to the accelerator pedal 9 may also be calculated based on a distance from a preceding vehicle, an acceleration (or deceleration) of the vehicle 1, or a drive force to propel the vehicle 1, instead of the above-explained speed difference Vd. Turning to FIG. 9, there is shown another example of the routine to adjust the reaction force based on the above-mentioned parameters. In FIG. 9, common step numbers are allotted to the steps in common with those in the routine shown in FIG. 3, and detailed explanation for the common steps will be omitted.

For example, in a case of employing a distance from the preceding vehicle as a parameter to correct the reaction force, the maps shown in FIGS. 4 and 5 are modified to correct the reaction force based on the distance from the preceding vehicle. In this case, at step S100, a target distance from the preceding vehicle which can avoid causing traffic congestion is calculated, and a current distance from the preceding vehicle is obtained. Then, at step S200, a difference between the target distance from the preceding vehicle and the current distance from the preceding vehicle is calculated. If the current distance from the preceding vehicle is shorter than the target distance from the preceding vehicle, the reaction force is increased. By contrast, if the current distance from the preceding vehicle is longer than the target distance from the preceding vehicle, the reaction force is reduced. Consequently, the distance from the preceding vehicle is adjusted to the target distance possible to alleviate traffic congestion.

In a case of employing an acceleration of the vehicle 1 as a parameter to correct the reaction force, the maps shown in FIGS. 4 and 5 are modified to correct the reaction force based on the acceleration of the vehicle 1. In this case, at step S100, a target acceleration of the vehicle 1 which can avoid causing traffic congestion is calculated, and a current acceleration of the vehicle 1 is obtained. Then, at step S200, a difference between the target acceleration of the vehicle 1 and the current acceleration of the vehicle 1 is calculated. If the current acceleration of the vehicle 1 is smaller than the target acceleration, the reaction force is reduced. By contrast, if the current acceleration of the vehicle 1 is greater than the target acceleration, the reaction force is increased. Consequently, the acceleration of the vehicle 1 is adjusted to the target acceleration possible to alleviate traffic congestion.

In a case of employing a drive force to propel the vehicle 1 as a parameter to correct the reaction force, the maps shown in FIGS. 4 and 5 are modified to correct the reaction force based on the drive force to propel the vehicle 1. In this case, at step S100, a target drive force to propel the vehicle 1 which can avoid causing traffic congestion is calculated, and a current drive force to propel the vehicle 1 is obtained. Then, at step S200, a difference between the target drive force to propel the vehicle 1 and the current drive force to propel the vehicle 1 is calculated. If the current drive force to propel the vehicle 1 is smaller than the target drive force, the reaction force is reduced. By contrast, if the current drive force to propel the vehicle 1 is greater than the target drive force, the reaction force is increased. Consequently, the drive force to propel the vehicle 1 is adjusted to the target drive force possible to alleviate traffic congestion.

In addition, the reaction force control system according to the embodiment of the present disclosure may also be applied to a conventional organ-type accelerator pedal instead of the accelerator pedal 9. Further, the reaction force control system according to the embodiment of the present disclosure may also be applied to a front-drive layout vehicle and an all-wheel-drive layout vehicle.

What is claimed is:

1. A reaction force control system for an accelerator pedal, comprising:
a reaction force generating mechanism that generates a reaction force against a pedal force applied to the accelerator pedal from a driver; and
a controller that controls the reaction force generating mechanism,
wherein the controller is configured to
determine whether the vehicle currently travels within a speed management zone,
obtain a current reaction force generated by the reaction force generating mechanism and calculate a target reaction force against the pedal force applied to the accelerator pedal from the driver, when the vehicle travels within the speed management zone,
reduce the reaction force when the current reaction force is greater than the target reaction force, and
increase the reaction force when the current reaction force is less than the target reaction force.

2. The reaction force control system for the accelerator pedal as claimed in claim 1, wherein the controller is further configured to
reduce the reaction force at a predetermined change rate possible to reduce uncomfortable feeling of the driver, and
increase the reaction force at the predetermined change rate possible to reduce uncomfortable feeling of the driver.

3. The reaction force control system for the accelerator pedal as claimed in claim 1, wherein the controller is further configured to
obtain the current reaction force based on an operating amount of the accelerator pedal,
calculate the target reaction force based on the current reaction force and a correction amount of the reaction force,
calculate the correction amount based on a difference between a current speed of the vehicle and a target speed of the vehicle,
increase the reaction force by the correction amount when the current speed of the vehicle is higher than the target speed, and
reduce the reaction force by the correction amount when the current speed of the vehicle is lower than the target speed.

4. The reaction force control system for the accelerator pedal as claimed in claim 1, wherein the controller is further configured to
obtain the current reaction force based on an operating amount of the accelerator pedal,
calculate the target reaction force based on the current reaction force and a correction amount of the reaction force,
calculate the correction amount based on a difference between a current distance from a preceding vehicle and a target distance from the preceding vehicle,
increase the reaction force by the correction amount when the current distance from the preceding vehicle is shorter than the target distance from the preceding vehicle, and
reduce the reaction force by the correction amount when the current distance from the preceding vehicle is longer than the target distance from the preceding vehicle.

5. The reaction force control system for the accelerator pedal as claimed in claim 1, wherein the controller is further configured to
obtain the current reaction force based on an operating amount of the accelerator pedal,
calculate the target reaction force based on the current reaction force and a correction amount of the reaction force,
calculate the correction amount based on a difference between a current acceleration of the vehicle and a target acceleration of the vehicle,
increase the reaction force by the correction amount when the current acceleration of the vehicle is greater than the target acceleration, and
reduce the reaction force by the correction amount when the current acceleration of the vehicle is less than the target acceleration.

6. The reaction force control system for the accelerator pedal as claimed in claim 1, wherein the controller is further configured to
obtain the current reaction force based on an operating amount of the accelerator pedal,
calculate the target reaction force based on the current reaction force and a correction amount of the reaction force,
calculate the correction amount based on a difference between a current drive force and a target drive force,
increase the reaction force by the correction amount when the current drive force is greater than the target drive force, and
reduce the reaction force by the correction amount when the current drive force of the vehicle is less than the target drive force.

7. The reaction force control system for the accelerator pedal as claimed in claim 1,
wherein speed management zone includes a zone where traffic congestion is expected to be caused, and
the controller is further configured to determine whether traffic congestion is expected to be caused based on a road gradient or a travelling route.
